(19) United States
(12) Patent Application Publication
(10) Pub. No.: US 2012/0146383 A1
(43) Pub. Date: Jun. 14, 2012

(54) Baby Safe Seatbelt

(76) Inventor: Pamela Kaye Chenault, Atlanta, GA (US)

(21) Appl. No.: 13/315,419

(22) Filed: Dec. 9, 2011

Related U.S. Application Data
(60) Provisional application No. 61/421,539, filed on Dec. 9, 2010.

(51) Int. Cl. B60R 22/10

(52) U.S. Cl. 297/468

(57) ABSTRACT

A child safe seatbelt comprising a belt configured to (i) releasably engage securely around the waist of a child and (ii) be engaged by a passenger seatbelt that is secured to a moving vehicle. The passenger seatbelt that engages the child safe seatbelt may be secured to a passenger such that the child secured by the child seatbelt sits on the passenger's (e.g., adult's) lap, and the child seatbelt is secured around the child's waist and engaged by the passenger seatbelt that is secured around the waist of the passenger on whose lap the child is sitting. The child seatbelt may be secured both to a child and to a passenger seatbelt that is not secured to a passenger, such that the child secured by the child seatbelt sits on a seat of a vehicle, and the passenger belt of the vehicle seat engages and secures the child seatbelt. The vehicle may be an airplane.

### RELATED APPLICATIONS

This application claims the benefit of U.S. Provisional Application No. 61/421,539, filed Dec. 9, 2010, which is incorporated herein by reference in its entirety.

### TECHNICAL FIELD

The present invention relates generally to methods and apparatus for securing a child, such as an infant or toddler, in a moving vehicle (e.g., automobile, train, airplane) and, more particularly, to a seatbelt that is (i) configured to secure around the waist of a child (referred to, for convenience, as “the child seatbelt”) and (ii) configured to be engaged by a seatbelt that is secured to the moving vehicle [e.g., a vehicle's seatbelt that is normally used to secure a passenger (e.g., capable of securing an adult), referred to herein for convenience as a “passenger seatbelt”). Embodiments of the present invention are particularly well suited for safely securing children in an airplane.

### BACKGROUND

Properly restraining children in transportation vehicles (e.g., automobiles, trains, airplanes) is of paramount importance for safety. Some transportation vehicles (e.g., trains) may not include a restraint system (e.g., seatbelt), while even in vehicles that do include passenger restraints (such as automobiles or airplanes), such passenger restraint systems that are useable by adults may be unuseable and/or inadequate for safely securing a child. Indeed, in view of such unuseability and/or inadequacy of automobile seatbelts, specific laws and regulations are in place for safely restraining children in automobiles. Yet no similar laws or regulations are in place for safely restraining children in, for example, airplanes. With respect to children under two years of age, some parents, rather than purchasing an airline ticket for separately seating the child, will hold the child in their lap. Additionally, even where a child may be seated separately in the child's own seat, the conventional airline seatbelt designed to restrain adult sized individuals is not well suited and may be inadequate for securing a child. While some parents may bring along a carseat for use in the child's seat, many do not do so, as carseats are generally cumbersome and inconvenient for passengers to carry into the cabin along with their carry-on luggage and child or children. In any case, even when a child does have his/her own seat and may even be secured in a carseat, the parent may nonetheless occasionally remove the child from the child's seat and place the child on the parent's lap. As such, there remains a need for new restraint systems for safely securing a child in transportation vehicles. It would also be advantageous if such a new restraint system may be used when the child is on the parent's lap and also used when the child is in his/her own seat.

### SUMMARY

In some embodiments, the child seatbelt is secured both to a child and to a passenger seatbelt that is secured to a passenger. For example, the child secured by the child seatbelt sits on the passenger's (e.g., adult's) lap, and the child seatbelt is secured around the child's waist and engaged by the passenger seatbelt that is secured around the waist of the passenger on whose lap the child is sitting. In some embodiments, such as may be implemented for a child 3 or more years old (e.g., who must sit in a separate seat according to FAA requirements), the child seatbelt is secured both to a child and to a passenger seatbelt that is not secured to a passenger (e.g., the child secured by the child seatbelt sits on the airplane seat, and the passenger belt of the airplane seat engages and secures the child seatbelt).

In accordance with some embodiments, the child seatbelt comprises at least one loop portion disposed such that when the child seatbelt is secured around the child's waist and engaged by the passenger seatbelt with the child sitting on the passenger's lap with the child generally facing the same direction as the passenger (e.g., the child's back disposed generally facing the passenger's stomach, chest, or flank region), the at least one loop portion is disposed generally between the child and the passenger. Similarly, the child seatbelt comprises at least one loop portion disposed such that when the child seatbelt is secured around the child's waist and engaged by the passenger seatbelt with the child sitting on the passenger seat itself (i.e., the child not sitting on a passenger), the at least one loop portion is disposed generally between the passenger seatback and the lower back and/or rear flank of the child.

It will be appreciated by those skilled in the art that the foregoing brief description and the following detailed description are exemplary (i.e., illustrative) and explanatory of the present invention, but are not intended to be restrictive thereof or limiting of the advantages which can be achieved by this invention. Additionally, it is understood that the foregoing summary and ensuing detailed description are representative of some embodiments of the invention, and are neither representative nor inclusive of all subject matter and embodiments within the scope of the present invention. Thus, the accompanying drawings, referred to herein and constituting a part hereof, illustrate embodiments of this invention, and, together with the detailed description, serve to explain principles of embodiments of the invention.

### BRIEF DESCRIPTION OF THE DRAWINGS

Aspects, features, and advantages of embodiments of the invention, both as to structure and operation, will be understood and will become more readily apparent when the invention is considered in the light of the following description made in conjunction with the accompanying drawings, which are meant to be exemplary and not limiting, and in which like reference numerals designate the same or similar parts, elements, or functions throughout the various figures, and wherein:

FIGS. 1-6 depict illustrative embodiments of child safe seatbelts, in accordance with some embodiments of the present invention.

### DETAILED DESCRIPTION OF EMBODIMENTS

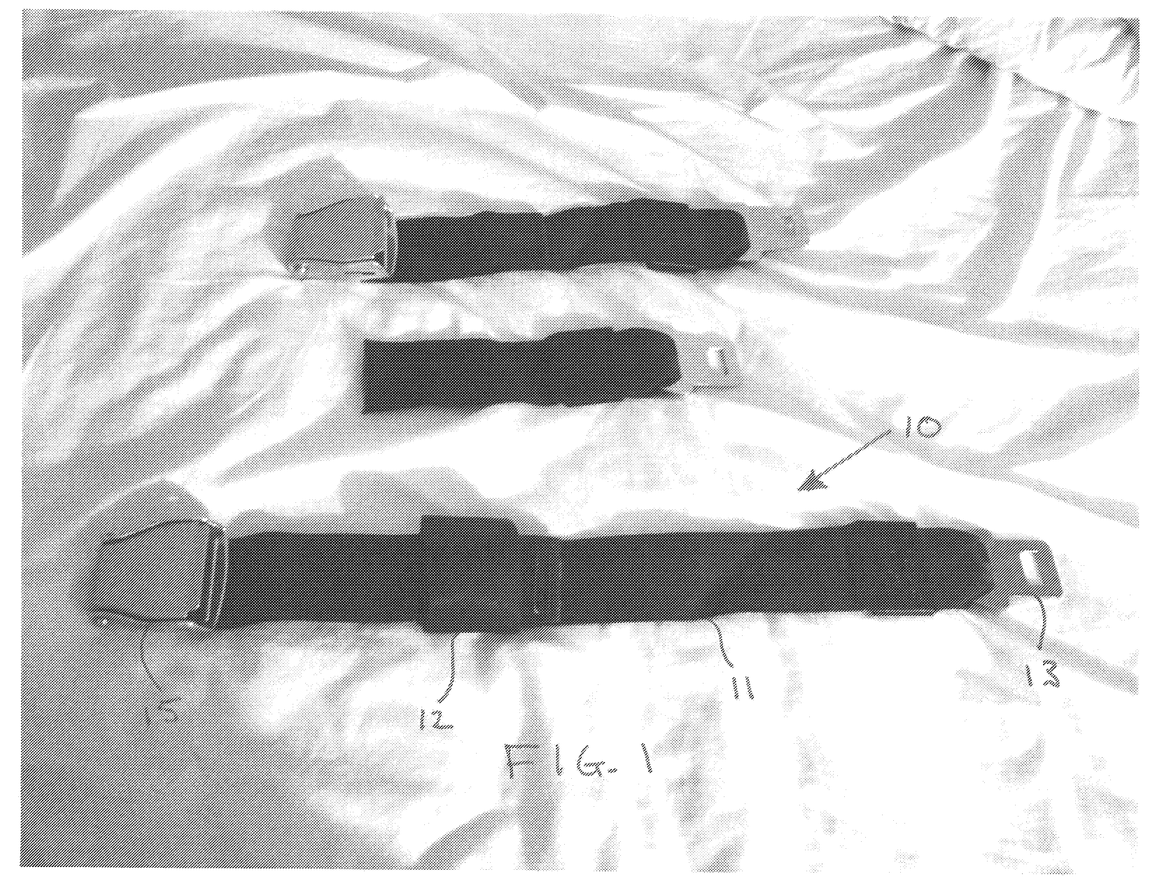

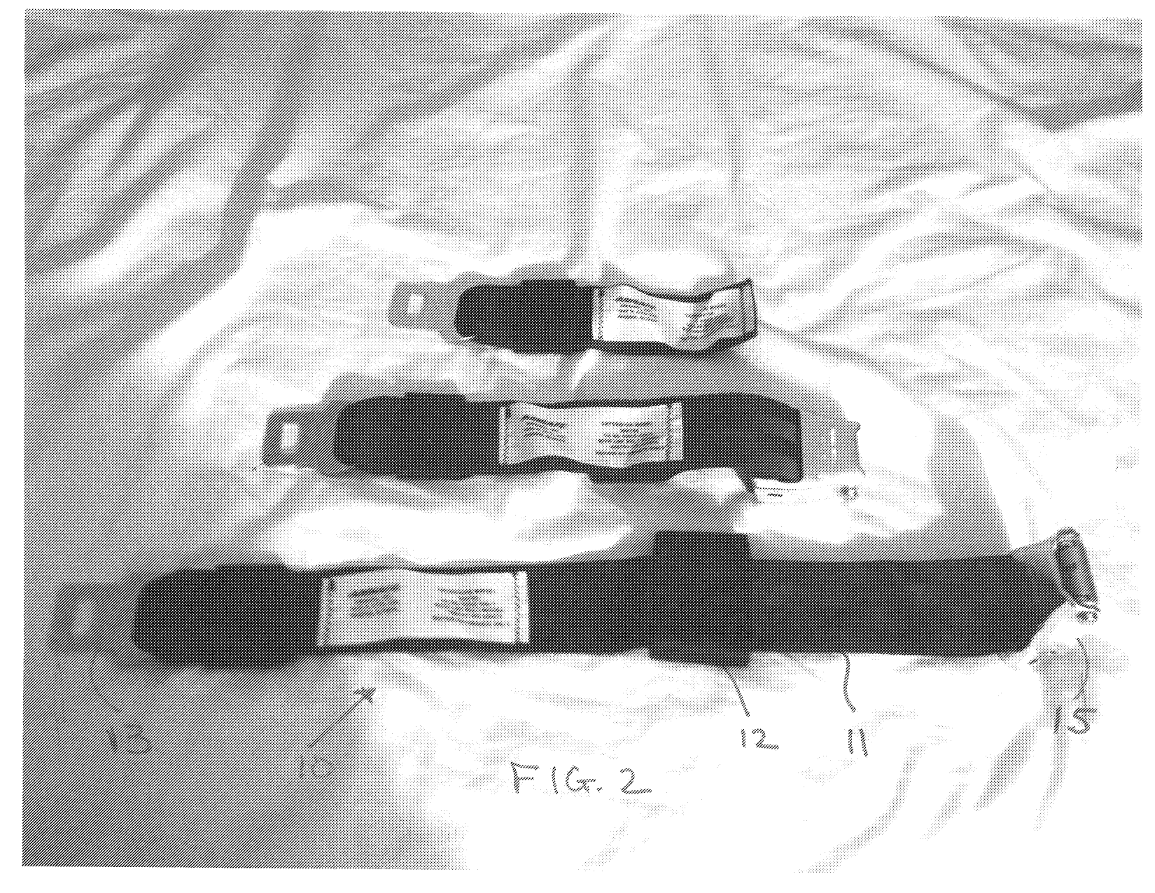

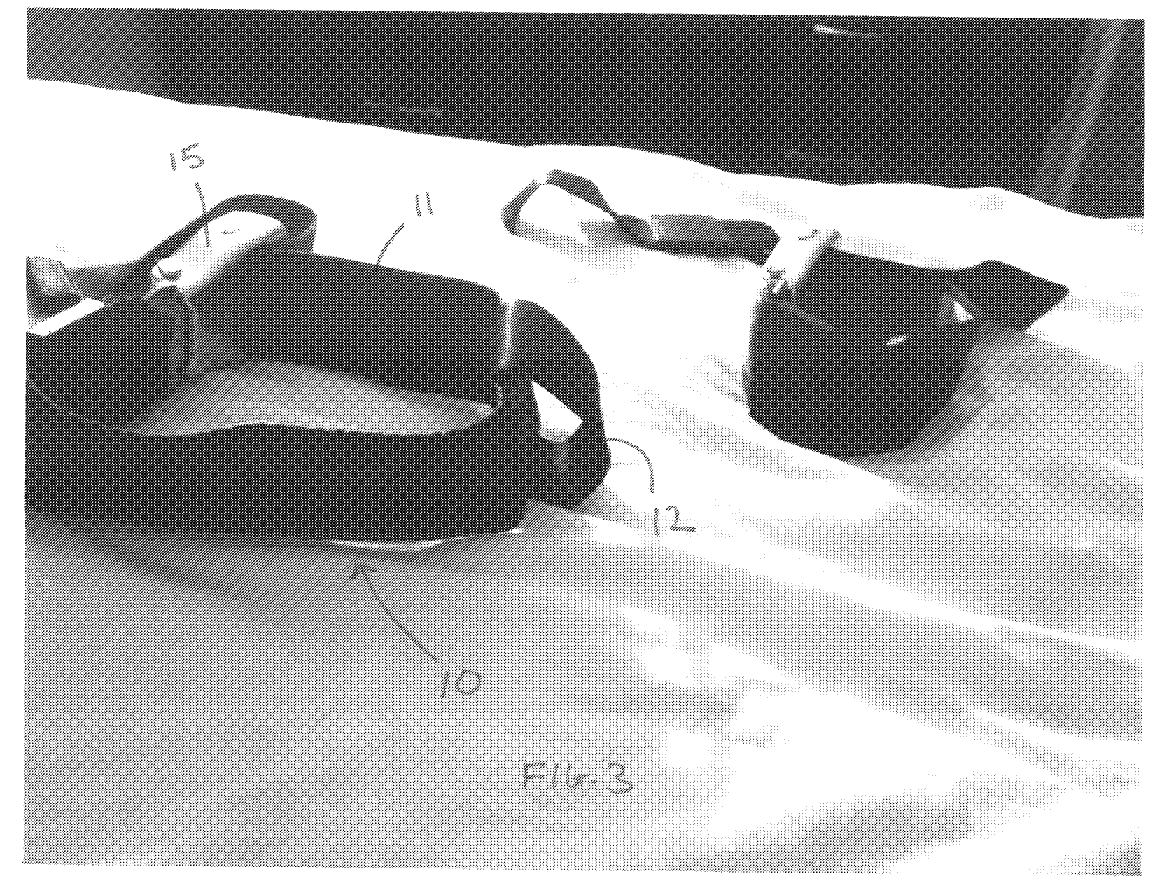

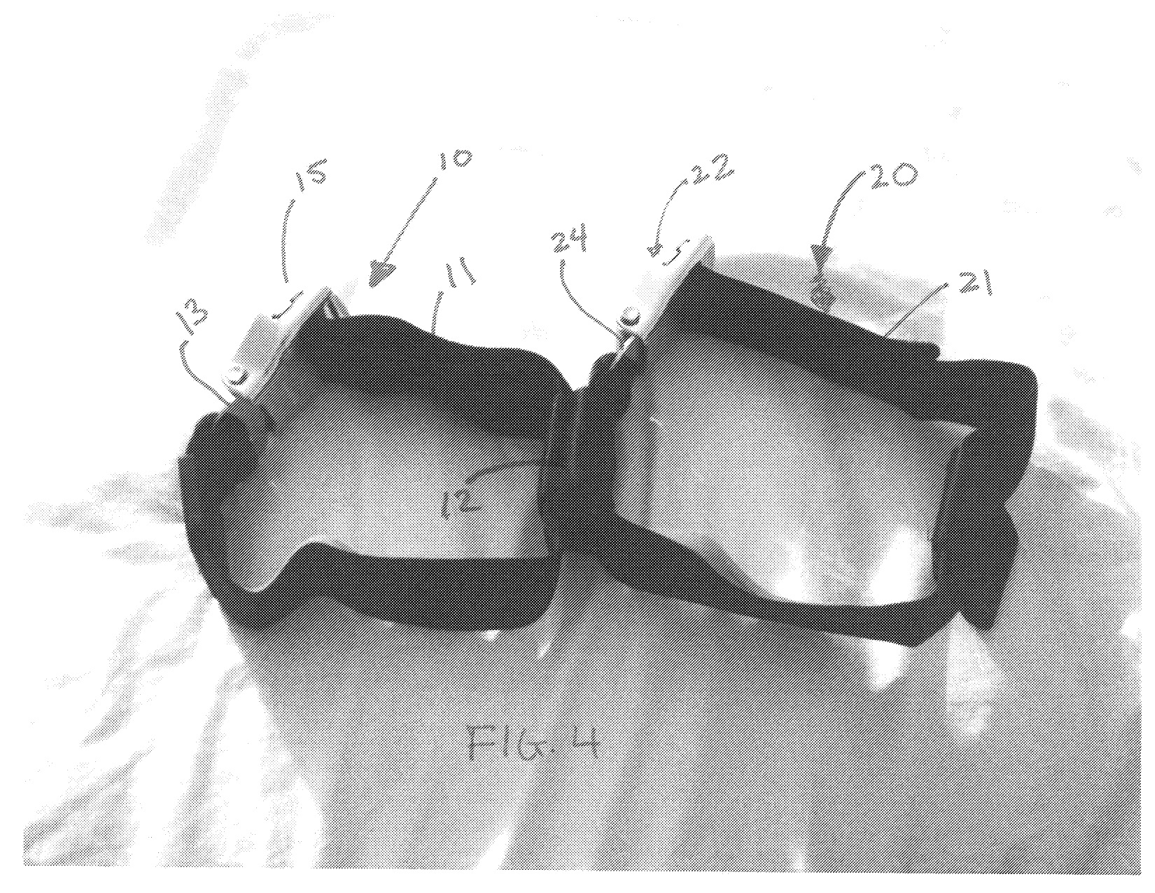

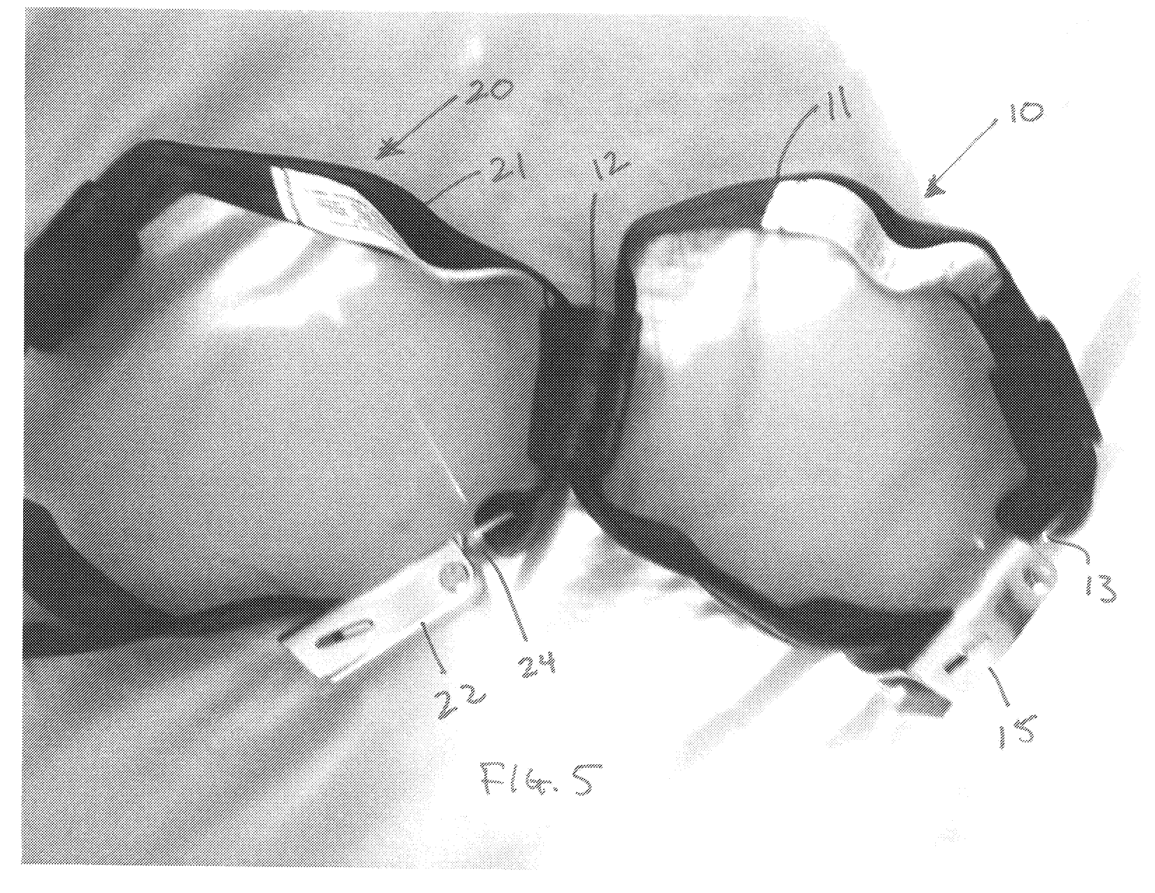

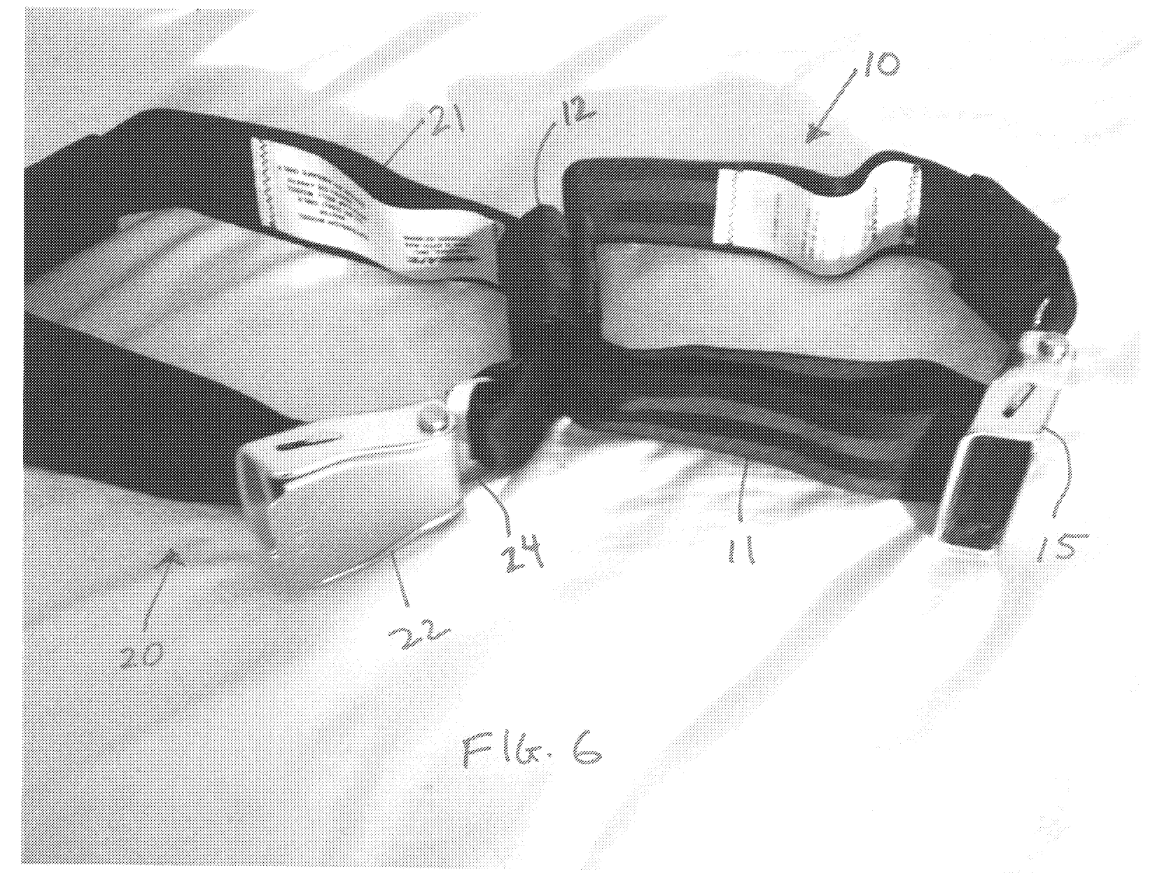

With reference to FIGS. 1-6, the ensuing description provides illustrative embodiments directed, by way of example, to child safe seatbelts for airlines, for which there is a great need for improved safe child restraint systems, and for which embodiments of the present invention are particularly well suited. More specifically, these figures depict an illustrative embodiment of a baby safe seatbelt 10, comprising (i) a length adjustable belt that includes strap/belt 11 and a latching buckle mechanism including latch/release 15 and buckle 13, and (ii) a loop portion 12. As will be understood, various embodiments may employ more than one loop portion, and loop portion 12 may be affixed to strap/belt 11 in various ways (e.g., stitching and/or other fastening mechanisms) and/or integrally formed therewith. In various of these figures, a passenger seatbelt 20 (e.g., typically affixed to the airplane seat for securing a passenger (e.g., adult) in the seat) is also shown, with the passenger seatbelt comprising a length adjustable belt that includes strap/belt 21 and a latching buckle mechanism including latch/release 22 and buckle 24. In various embodiments, baby safe seatbelt 10 may be constructed similarly to passenger seatbelt 20, but further include at least one loop portion 12 and also have a length that is adjustable to secure around the waist of a child (e.g., an infant or a toddler). Baby safe seatbelts may also be provided in differing adjustable length ranges (e.g., a length range for infants, a length range for toddlers), though a baby safe seatbelt may be implemented with a sufficiently large range of adjustability so as to cover essentially all children that my use the baby safe seatbelt.

As noted, some implementations of the baby safe seatbelt 10 may be similar to a conventional seatbelt, but may be adjustable up to approximately one half the length of a full passenger seatbelt, and will also include a loop 12. Loop 12 may be made from the same material as the seatbelt that is attached to the airplane and, in some implementations, is sewn to approximately the middle of the backside of the strap/belt 11 of baby safe seatbelt 10.

The opening of the loop 12 faces the outside (i.e., away from the child when the child is secured in the baby safe seatbelt 10, and is large enough to provide sufficient space for inserting/threading one side of the passenger seatbelt through loop 12. In accordance with some embodiments, preferably the loop is large enough to permit the buckle 24 of passenger seatbelt 20 to be inserted therethrough, but small enough such that latch/release 22 cannot pass therethrough. As such, in such implementations, with the baby seated on a passenger's (e.g., parent's) lap, baby safe seatbelt 10 will allow mobility from left to right to center on one side of the parent's seatbelt, but prevent or restrict movement to the other side of the parent's seatbelt.

The passenger (parent) may secure/latch the baby safe seatbelt 10 around the child (around child's waist) either before or after the passenger loops their passenger seatbelt through the loop 12. After looping their passenger seatbelt through the loop 12, the passenger may fasten/buckle their seatbelt in the usual way. In this way, in accordance with some embodiments, the child will be secured to his/or her parent (or other passenger) who is secured by the passenger seatbelt, and thus providing the parent with hands-free secure mobility, while securing the child in case of emergency, turbulence, or the like.

In an emergency, the parent needs only to release their passenger seatbelt and remove their passenger seatbelt (one side) out of the Baby Safe Loop 12. The child will still be attached to their child seatbelt at all times, and thus may be easily re-secured to a passenger seatbelt (with or without a parent secured in the passenger seatbelt) via loop 12, thereby providing easy mobility for the parent while also providing ready security for the child if at any given moment the instruction is given to fasten seatbelts while the child is not secured (e.g., playing on the floor).

As described above, in accordance with various implementations, the baby safe seatbelt may be secured/engaged by a passenger seatbelt, with the child seated directly in the passenger seat (i.e. not on a passenger lap). In some such embodiments, more than one loop 12 (e.g., three loops) for engagement by the passenger seatbelt may be advantageous to provide for securing the child and preventing excessive movement (e.g., side-to-side movement).

The present invention has been illustrated and described with respect to specific embodiments thereof, which embodiments are merely illustrative of the principles of the invention and are not intended to be exclusive or otherwise limiting embodiments. Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. It is further noted that the terms and expressions have been used as terms of description and not terms of limitation. There is no intention to use the terms or expressions to exclude any equivalents of features shown and described or portions thereof. Additionally, the present invention may be practiced without necessarily providing one or more of the advantages described herein or otherwise understood in view of the disclosure and/or that may be realized in some embodiments thereof. It is therefore intended that the present invention is not limited to the disclosed embodiments but should be defined in accordance with the claims that follow.

What is claimed is:

1. A seatbelt comprising a belt configured to (i) releasably engage securely around the waist of a child and (ii) be engaged by a passenger seatbelt that is secured to the moving vehicle.

2. The seatbelt according to claim 1, wherein the belt is length adjustable and comprises a strap and a latching buckle mechanism, and wherein the seatbelt comprises at least one loop portion configured to be engaged by the passenger seatbelt so as to secure the seatbelt.

3. The seatbelt according to claim 2, wherein the at least one loop portion is fastened to said strap.

4. The seatbelt according to claim 3, wherein the at least one loop portion is fastened to said strap via at least one fastener comprising stitching.
